(19) United States
(12) Patent Application Publication
(10) Pub. No.: US 2022/0314572 A1
(43) Pub. Date: Oct. 6, 2022

(54) MAGNETICALLY ATTACHABLE PROTECTIVE FILM

(71) Applicant: Shenzhen Lifengda Technology Co., Ltd, Shenzhen City (CN)

(72) Inventor: Zhijun DENG, Changning City (CN)

(21) Appl. No.: 17/339,611

(22) Filed: Jun. 4, 2021

(30) Foreign Application Priority Data
Mar. 30, 2021 (CN) 202120663966.9

(51) Int. Cl. B32B 3/06; B32B 3/08

(52) U.S. Cl. CPC B32B 3/06; B32B 3/08; B32B 2307/7145; B32B 2307/42; B32B 2307/584; B32B 2307/762; B32B 2307/208; B32B 2307/744; B32B 2457/20; B32B 2571/00

(57) ABSTRACT

This utility model is a kind of magnetically attachable protective film, which relates to the technical field of protective film. The film includes the film itself, the magnetically attachable layer arranged on the edge of the film for adsorption and fixation on the screen, and an anti-slip layer set at the magnetically attachable layer and/or the film and near one side of the screen. The above technical proposal has the advantages of facilitating film pasting and replacing, strengthening the attachment fixation, simplifying the structure, and providing good user experience.

### TECHNICAL FIELD

The disclosure relates generally to the technical field of protective film, and specifically to a kind of magnetically attachable protective film.

### BACKGROUND ART

Screen protection film is a transparent medium using at present mainly PET as raw material from Taiwan or Japan. Ordinary screen protection films only have the effect of dust prevention, while better ones have crystal scratch-resistant coating to resist scratches. The best screen protective films bear certain metal elements, thus protects from electromagnetic waves, reduce electromagnetic radiation and the dazzling feeling generated by watching the screen for a long time simultaneously, effectively protect the computer screen from scratches and damage.

Since it's quite difficult to paste screen protective film, both the yield and quality are not high even pasting by professionals, and magnetically attachable protective film can satisfy people's needs because secondary use of replaced protective film can hardly be made. However, the existing magnetically attachable protective film is prone to shift in use, especially when the user is writing or drawing on the screen, and this affects the users to use the screen to a large extent, so it needs to be improved.

Content of the Utility Model

The utility model aims at providing a magnetically attachable protective film which has the advantages of being relatively easy to be pasted and replaced, strong in attachment fixation, simple in structure, and good in user experience specific to the defects and deficiencies of the prior art.

To reach the purpose, the technical proposal of the utility model is that a magnetically attachable protective film includes the film itself, the magnetically attachable layer arranged on the edge of the film for adsorption and fixation on the screen, and an anti-slip layer set at the magnetically attachable layer and/or the film and near one side of the screen.

The anti-slip layer is arranged along the edge of the screen, and the magnetically attachable protective film also includes a corrugation preventing layer arranged between the anti-slip layer and the film.

The anti-slip layer is a concave-convex surface on the side far away from the film.

The anti-slip layer is strip- or box-shaped.

The magnetically attachable layer is strip- or box-shaped

The film combines any one or more of the successively layered paper film, privacy protection film, anti-bacterial film, anti-glare film, self-healing film, anti-scratch film, anti blue light film and/or AR (anti-reflection) film.

The adoption of the technical proposal brings the utility model the following beneficial effects:
I. The difficulty of film pasting is effectively reduced, and the film yield is improved through the setting of the magnetically attachable layer. Furthermore, it's also easy to replace protective films of different functions.
II. The adsorption fixity between the magnetic protective film and the screen is effectively improved through the setting of the anti-slip layer, that is, further fixation is realized by increasing the friction between the protective film and the screen based on the magnetic absorption fixation of the magnetic adsorption layer and the screen in use, thereby preventing the magnetically attachable protective film from shifting in use.
III. Corrugation is avoided by the corrugation preventing layer arranged between the anti-slip layer and the film while attaching the magnetically attachable protective film to the screen.

### DESCRIPTION OF THE DRAWINGS

To make the technical proposal of the art or this utility model embodiment clearer, the drawing sheets of the embodiment or the art will be simply described as follow. Clearly, the drawing sheets described below are just a plural of the utility model embodiment. For ordinary technical personnel in the field, additional drawings are also available based on these drawings under the premise of not making a creative effort.

FIG. 1 is the structure diagram of the utility model;

FIG. 2 illustrates a side view of FIG. 1.

FIG. 3 is the status diagram of using the utility model for Tablet PC.

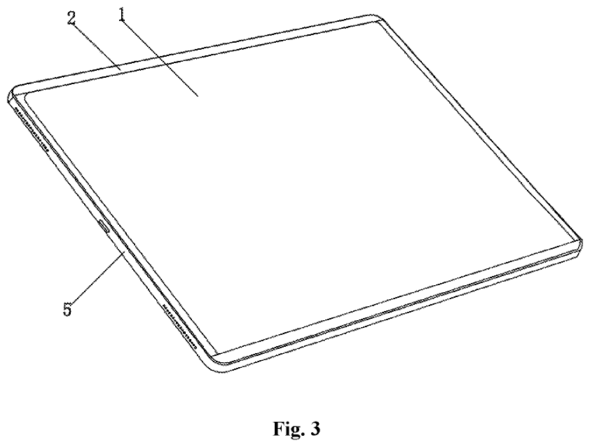

FIG. 4 is the structure diagram of the utility model after being disassembled from the Tablet PC.

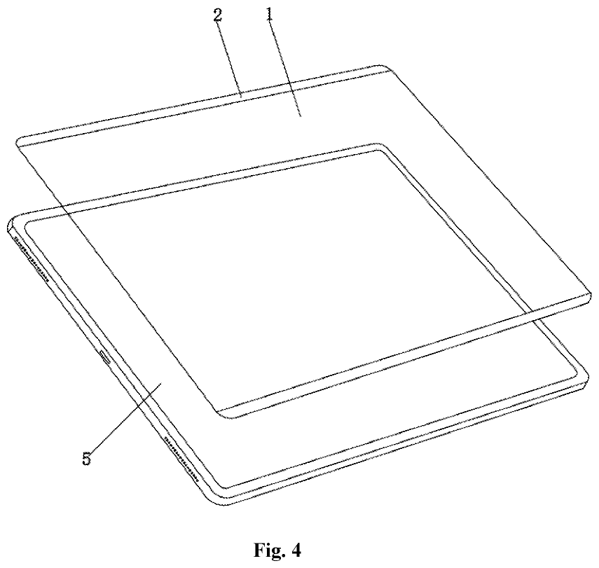

FIG. 5 is the status diagram of using the utility model for laptop.

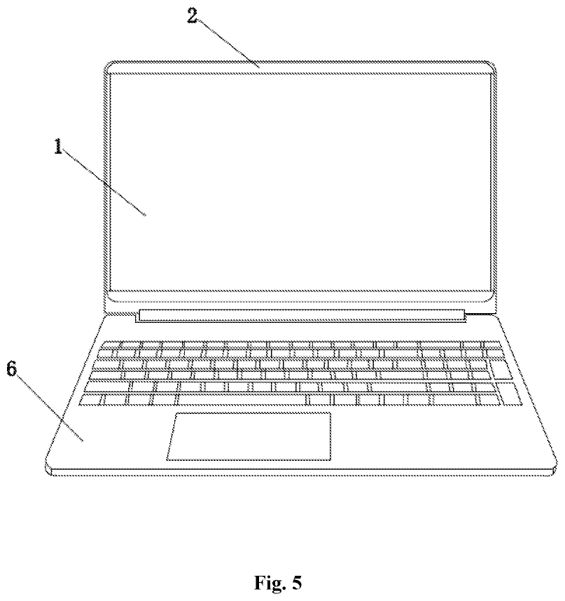

Marking description: 1. The film; 2. The magnetically attachable layer; 3. The anti-slip layer; 4. The corrugation preventing layer; 5. The Tablet PC; 6. The laptop.

### The Embodiment

The utility model is further specified in combination with the drawings below.

This embodiment is only an interpretation of the utility model and is not a limitation hereof. One skilled in the art would readily make modifications hereto without creating contributions as needed after having read this specification, and the modifications are protected by the Patent Law as long as they are within the scope of the claims of the utility model.

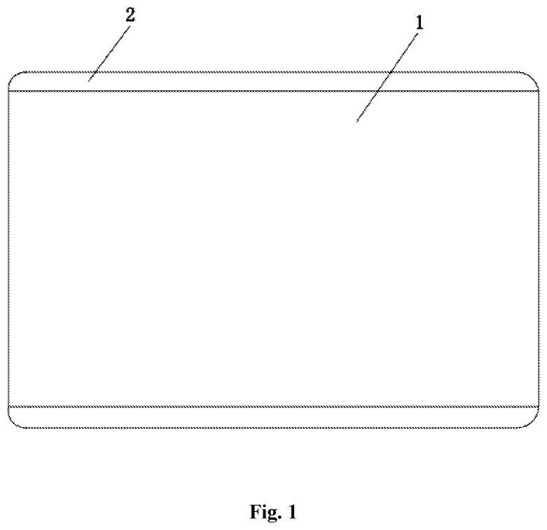

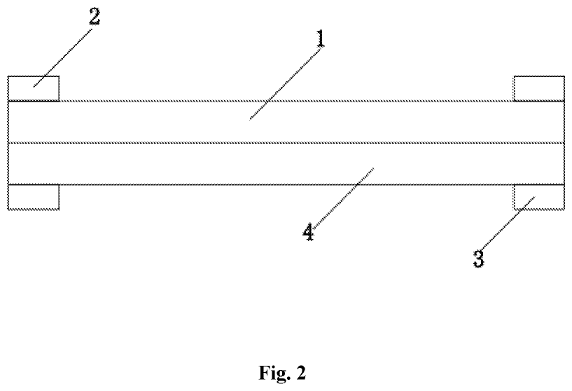

This embodiment relates to a magnetically attachable protective film suitable for Tablet PC 5 and laptop 6. As shown in FIG. 1 and FIG. 2, the utility model consists of the film 1, the magnetically attachable layer 2, the anti-slip layer 3, and the corrugation preventing layer 4.

In this embodiment, the magnetically attachable layer 2, the film 1, the corrugation preventing layer 4, and the anti-slip layer 3 are stacked from top to bottom. The magnetically attachable layer 2 and the screen are closely bound up to fix the magnetically attachable protective film on the screen. The magnetically attachable layer 2 is made of magnetic materials. Arranged along the edge of the screen, the anti-slip layer 3 increases its friction with the screen to prevent the magnetically attachable protective film from shifting when the screen is in use.

Furthermore, both the anti-slip layer 3 and the magnetically attachable layer 2 are strip- or box-shaped. Preferably, both the magnetically attachable layer 2 and the anti-slip layer 3 are strip-shaped, and the anti-slip layer 3 is arranged on the corrugation preventing layer corresponding to the magnetically attachable layer 2. In other embodiments, the magnetically attachable layer 2 is arranged on the corrugation preventing layer 4 on the side away from or embedded in the film 1. The magnetically attachable layer 2 can also be arranged between the film 1 and the corrugation preventing layer 4, or between the corrugation preventing layer 4 and the anti-slip layer 3.

Because it is difficult to generate shear force, and relative slip is prone to occur between two relatively smooth hard planes, the anti-slip layer is set as a soft layer with Shore hardness of d65 approximately. The anti-slip layer 3 is a concave-convex surface on the side far away from the film. From the microscopic point of view, the concave-convex surface can have the effect of a adhesive disc able to affix to the screen, so as to effectively avoid the misplacement of the magnetically attachable protective film relative to the screen.

The anti-slip layer 3 is made of UV hardening coatings, and the concave-convex surface on it is imprinted by concave-convex roller on the semi-solidified layers after the UV hardening coating is irradiated with UV.

Naturally, there is a layer of water film on both the screen surface and the film 1 surface, and both of which are relatively smooth. When they are affixed to each other, water ripples would appear on the pasting surface and affect the use of the screen. Therefore, the side of the corrugation preventing layer 4 near the screen is roughed as a concave-convex surface, which can avoid corrugation when the magnetically attachable protective film is attached to the screen.

Furthermore, the film 1 combines any one or more of the successively layered paper film, privacy protection film, anti-bacterial film, anti-glare film, self-healing film, anti-scratch film, anti blue light film and/or AR (anti-reflection) film.

In this embodiment, the film 1 is a paper film. Paper film is a film with concave-convex surface imprinted by concave-convex roller on the semi-solidified hardening resin and irradiated with UV for curing after the hardening resin is evenly rolled onto the surface of the substrate layer. When writing on the film, it feels like writing with a pencil on paper, and thus can effectively improve the user's writing experience.

In addition, the anti-scratch film is prepared as follows:

Prepare epoxy resin, trimethylpropane triacrylate, initiating agent, flatting agent, defoaming agent and dispersant. Select benzoin ethyl ether as the initiating agent, and zinc stearate as the dispersant. Evenly mix the components first, then evenly smear the mixture on the substrate layer, and finally cure it by UV irradiation for preparation, Wherein, the substrate layer involves PET, TAC or PMMA.

The anti-bacterial film is prepared by the following method: Prepare the carrier, copper ion, silver ion and hardening coating. Wherein, the carrier is glass or zeolite. Mix the carrier, copper ion and silver ion to get anti-bacterial agent, then add the anti-bacterial agent to the hardening coating, and finish the preparation after curing.

The preparation method of anti blue light film is as follows: Add blue light blocker into the hard coating, then coat the surface of the substrate layer evenly to prevent 480 nm light from entering human eyes and effectively avoid chloasma lesions of eyes.

It needs to be noted that paper film, privacy protection film, anti-bacterial film, anti-glare film, self-healing film, anti-scratch film, anti blue light film and AR (anti-reflection) film are the prior arts, and the preparation methods of privacy protection film, anti-glare film, self-healing film and AR (anti-reflection) film will not be described here.

Generally, the working principle of this utility model is as follow: Put the magnetically attachable protective film near the edge of the screen and let it be fastened to the screen under the action of the screen and the magnetically attachable layer 2 for use, and realize further fixation under the action of anti-slip layer 3 to effectively improve the immobility of the magnetically attachable protective film and the screen, and thereby preventing the magnetically attachable protective film from shifting while the screen is in use.

The above only describes the technical proposal of this utility model, and does not exert any restriction. Other modifications or equivalent substitutions made by ordinary technicians in the field shall be covered in the claims of this utility model as long as they do not deviate from the spirit and scope of the technical proposal of this utility mode.

1. A magnetically attachable protective film comprising:
a protective film;
a magnetically attachable layer arranged on an edge of the protective film for attachment and fixation on a screen, and
an anti-slip layer adhered to the magnetically attachable layer and the protective film and attached to the screen.

2. The magnetically attachable protective film of claim 1, wherein the anti-slip layer includes a surface includes multiple concave areas and multiple convex areas.

3. The magnetically attachable protective film of claim 2,
wherein the anti-slip layer is arranged along the edge of the screen, and
wherein the magnetically attachable protective film further includes a corrugation preventing layer arranged between the anti-slip layer and the protective film.

4. The magnetically attachable protective film of claim 3, wherein the anti-slip layer is box-shaped.

5. The magnetically attachable protective film of claim 3, wherein the magnetically attachable layer is box-shaped.

6. The magnetically attachable protective film of claim 1, wherein the protective film includes at least one of paper-like film, privacy protection film, anti-bacterial film, anti-glare film, automatic repair film, anti-scratch film, anti blue light film and anti-reflection (AR) film.

7. The magnetically attachable protective film of claim 3, wherein the anti-slip layer is strip shaped.

8. The magnetically attachable protective film of claim 3, wherein the magnetically attachable layer is strip shaped.
